(19) United States
(12) Patent Application Publication
(10) Pub. No.: US 2023/0285920 A1
(43) Pub. Date: Sep. 14, 2023

(54) METHOD AND DEVICE FOR RECYCLING WASTE MATERIALS CONTAINING VALUABLE METALS

(71) Applicant: AURA Technologie GMBH, Helbra (DE)

(72) Inventors: Frank GÖRLITZ, Kleinmachnow (DE); Sebastian WESTPHAL, Halle (Saale) (DE)

(21) Appl. No.: 18/014,027

(22) PCT Filed: Jun. 24, 2021
(86) PCT No.: PCT/EP2021/067320

§ 371 Date: Dec. 30, 2022

(30) Foreign Application Priority Data
Jun. 30, 2020 (EP) 20183142.7

(51) Int. Cl. B01J 8/18; B01J 8/24; B09B 3/40; F23C 10/28

(52) U.S. Cl. CPC B01J 8/1809; B01J 8/24; B09B 3/40; F23C 10/28; B01J 2208/00504; F23G 2203/50

(57) ABSTRACT

The invention relates to processes for recycling waste materials containing valuable metals in a fluidized-bed furnace (100), comprising the phases I, start-up of the fluidized-bed furnace; and II, continuous reprocessing of the waste materials containing valuable metals, characterized in that the fluidized-bed furnace (100) is operated autothermally during the phase II of continuous reprocessing of the waste materials containing valuable metals, with the process temperature being regulated via the fill level of the fluidized-bed furnace (100) and the flow rate of material through the furnace. The invention further provides an apparatus comprising a fluidized-bed furnace (100) for recycling waste materials containing valuable metals in a continuous autothermal process.

### FIELD OF THE INVENTION

The invention relates to processes for recycling waste materials containing valuable metals in a fluidized-bed furnace, comprising the phases I) starting-up of the fluidized-bed furnace; and II) continuous treatment of the waste materials containing valuable metals, characterized in that the fluidized-bed furnace is operated autothermally during phase II of the continuous treatment of the waste materials containing valuable metals, with the process temperature being regulated via the fill level of the fluidized-bed furnace and the flow rate of material through the furnace. The invention further provides an apparatus comprising a fluidized-bed furnace for recycling waste materials containing valuable metals in a continuous autothermal process. The waste materials containing valuable metals originate, for example, from petroleum refineries and the chemical industry.

### BACKGROUND OF THE INVENTION

The invention is related, for example, to petroleum processing and petroleum upgrading. The crude oil obtained from the oil reservoirs is treated on-site for transport to the refinery, i.e. essentially roughly separated from sediments and water. After these first processing steps, the crude oil is delivered as petroleum to the refineries. Here, the liquid mixture is separated into different fractions in further complicated and successive individual steps and treated to give saleable products. Technology has today progressed to such an extent that no materials in the crude oil remain unused. Even the refinery gas which is always but undesirably obtained as byproduct, finds uses. It is either utilized directly as energy carrier in the process ovens or used as synthesis gas in further chemical processing. The work-up of petroleum comprises, inter alia, petroleum purification and desalting, known as primary processing, and secondary processing in which the petroleum is separated by means of distillation into constituents such as light petroleum spirit (naphtha), including kerosine, diesel fuel and light heating oil. The residue formed is redistilled in order to separate it into further products.

After secondary processing, a series of upgrading processes are employed in order to improve the quality of the intermediates. Virtually all mineral oil products which leave the refinery are not just merely distilled/rectified from petroleum. Thus, gasifier fuels, diesel fuel, heating oil (extra light) for dwellings and heating oil for industrial facilities (heavy heating oil) are made up by mixing various intermediates/components produced in the production processes mentioned below. In hydrotreating and the Claus process, desulfurization of the lubricating oils and heating oils obtained in fractional distillation is carried out. Since these products are rich in sulfur compounds, they would liberate toxic sulfur dioxide when burnt. In hydrotreating, the oils to be desulfurized are mixed with hydrogen and heated. The hot mixture goes into a reactor filled with a catalyst. At a temperature of about 350° C., the hydrogen reacts with the sulfur compounds to form hydrogen sulfide. In the subsequent Claus process, the hydrogen sulfide formed is burnt with atmospheric oxygen in a reactor. This allows sulfur to be isolated. Catalysts containing valuable metals such as nickel, molybdenum, tungsten or cobalt on aluminium oxide are used here. Similar catalysts containing valuable metals are used in hydrocracking and in platformer units.

Catalysts are also used in reforming. Catalytic reforming has the objective of increasing the octane number of raw petroleum spirit (boiling range 75-180° C.) and producing aromatic hydrocarbons. Furthermore, hydrogen is obtained as product and is used in hydrotreating processes and in hydrocracking processes. Reforming proceeds at about 500° C. and 5-40 bar in a moving bed reactor. Bifunctional catalysts (platinum-tin or platinum-rhenium, on chlorinated aluminium oxide or zeolites) are used here. The hydrogenation/dehydrogenation reactions preferentially proceed at the metal sites of the catalyst, while the acid sites catalyze isomerization and ring-closure reactions. An undesirable secondary reaction is carbonization of the catalyst by polymerization and dehydrogenation reactions. Carbonization is removed by burning off the carbon deposits and subsequent oxychlorination of the catalyst.

The life of catalysts is limited. Depending on the process, they lose their effectiveness in a period of from a few seconds to a number of years. Apart from the loss of activity, a deterioration in the selectivity also frequently occurs. After the catalyst efficiency has dropped below a desired limit value, the catalysts therefore have to be removed from the petroleum refinery processes and replaced by fresh catalysts. Regeneration of the catalyst batches originating from the petroleum refinery processes with the objective of reuse is, however, at present not possible without restrictions. The catalyst batches originating from the petroleum refinery processes therefore represent waste products which because of the high content of sulfur and oil constituents have to be classified as hazardous waste. In order to avoid high costs for disposal and storage as hazardous waste, the present invention provides a process and an apparatus with the aid of which waste materials containing valuable metals, for example the catalyst batches originating from petroleum refinery processes, can be worked up, i.e. hazardous sulfur and oil constituents can be effectively removed. The reprocessed catalyst batches have high contents of nickel, tungsten, molybdenum or cobalt and also aluminium oxide and represent sought-after raw materials in the steel industry. Waste materials containing valuable metals are obtained not only in petroleum refineries but also in other branches of industry in which materials containing valuable metals are contaminated with organic substances. The invention thus makes an important contribution to reducing the CO₂ footprint of this branch of industry and closes, as part of the circular economy, the materials circuit for the valuable metals mentioned.

The present invention is based on a fluidized-bed furnace which, after the start-up process, is operated autothermally and in which a continuous process for recycling the waste materials containing valuable metals, for example catalyst batches originating from petroleum refinery processes, is carried out.

Processes for reprocessing catalysts from petroleum refineries are, for example, known from CN104415797 A and CN104549564A. The reprocessing is, however, carried out here using regeneration agents additionally introduced into the fluidized-bed furnaces. In the process described in EP0710502 B1, relatively low process temperatures (300° C.-680° C.) are used and halogen-containing substances are introduced into the fluidized-bed furnace. The process described in DE4041976 A1 takes place under superatmospheric pressure (0.1-0.5 MPa) instead of reduced pressure. For this reason, there is the risk of harmful gases escaping from the reactor. EP0332536 B1 discloses a furnace having two chambers which each have different temperatures (T1<730° C., T2<950° C.).

Autothermal arrangements of fluidized-bed furnaces are described in the prior art only without reference to petroleum processing or catalyst work-up from petroleum refineries. Thus, DE19953233 A1 describes a process in which coupling in energy terms of an exothermic process and an endothermic process occurs, with both processes proceeding simultaneously. US20020034458 A1 discloses a process for obtaining pure hydrogen, for which purpose a steam/methane reforming reaction and an oxygen/methane oxygenation under autothermal conditions are utilized. In this process, gaseous hydrocarbons and steam are fed in. A catalyst serves for internal heat transport. GB1060141 A describes cracking of liquid hydrocarbons to give town gas, grid gas or gases having a relatively high calorific value at relatively low process temperatures (400° C.-600° C.) and with addition of steam. US3745940 A discloses a fluidized-bed furnace having four different zones in general terms. US4291635 A relates to processes and an apparatus for the continuous autogenous incineration of readily broken-up and combustible agglomerates of waste materials having a high moisture content in the range from about 50 to 75% in a fluidized bed.

The reprocessing of catalyst batches from petroleum upgrading is conventionally carried out in a two-stage fluidized-bed furnace, with the material to be reprocessed being introduced from above. One or more burners are generally arranged at the side. The movement of material occurs via flow plates of the fluidized-bed furnace and the combustion air. The conventional reprocessing methods are very energy-intensive since the burners have to be active for 24 hours every day. The conventional reprocessing methods are also inefficient since the material flow rate has to be reduced when the temperature in the fluidized-bed furnace rises above an intended temperature. In addition, the waste heat is released unutilized via the stack in the case of conventional fluidized-bed furnaces in the field of reprocessing of catalysts from petroleum refineries.

### DESCRIPTION OF THE INVENTION

The waste materials containing valuable metals which are to be worked up according to the invention have the special feature that they contain sulfur impurities and also combustible oil and carbon deposit residues. It was an object of the invention to provide a simple reprocessing method which is inexpensive in terms of energy and in which the emission of harmful gases is suppressed at the same time, i.e. an energy-efficient, environmentally friendly and low-CO₂-emission process should be provided.

The object of the invention is achieved by a process for recycling waste materials containing valuable metals according to Claim 1. The process is carried out in a fluidized-bed furnace and comprises the phases:
I. Start-up of the fluidized-bed furnace; and
II. Continuous processing of the waste materials containing valuable metals.

The fluidized-bed furnace is operated autothermally during phase II of the continuous processing of the waste materials containing valuable metals. The process is therefore particularly energy-efficient since heat has to be introduced only once during the start-up phase in order to reach the process temperature. The process is also particularly low in CO₂ emissions since no additional fuels have to be introduced for operating the fluidized-bed furnace during the continuous phase II. During phase II of the continuous processing of the waste materials containing valuable metals, the process temperature is regulated via the fill level of the fluidized-bed furnace and the flow rate of material through the furnace.

Waste materials containing valuable metals are in the widest sense all materials which contain valuable metals such as nickel, tungsten, molybdenum and/or cobalt and have been contaminated by treatment with organic materials, in particular hydrocarbons. Contaminated hydrocarbons are, for example, fossil fuels such as petroleum. The waste materials containing valuable metals originate from petroleum refineries, fuel production plants in which gas-to-liquids processes are carried out or from petroleum cracking processes. The waste materials containing valuable metals are preferably catalyst materials which have been used in the abovementioned processes and plants. The process of the invention and the fluidized-bed furnace of the invention are particularly suitable for recycling catalyst materials from the petroleum-processing and natural gas-processing industry, in particular from petroleum refineries.

Catalyst materials from petroleum refineries contain, for example, about 80% of aluminium oxide, about 12% of molybdenum and about 8% of nickel and/or cobalt. The catalyst batches also contain three particle size fractions: dust, larger fragments and a fraction comprising intact catalyst particles. Main impurities after use of the catalyst batches in petroleum upgrading processes are oil residues and sulfur.

It has been found to be particularly advantageous for the process temperature in the fluidized-bed furnace during the continuous, autothermal phase II to be held, depending on the valuable metal composition of the waste materials, in the range from 630° C. to 730° C. When the waste materials have a high proportion of tungsten, the temperature in the continuous, autothermal phase II is, in a particularly preferred embodiment of the process of the invention, maintained in the range from 630° C. to 650° C. In all other cases, the temperature in the continuous, autothermal phase II is preferably maintained in the range from 720° C. to 730° C. This ensures that the oil and carbon deposit residues adhering to the waste materials are essentially completely burnt off. Here, the oil and carbon deposit residues adhering to the waste materials containing valuable metals themselves serve as energy source for the autothermal process and help maintain the process temperature in the range from 630 to 730° C. Further external supply of energy or fuels is not provided for and not necessary during the continuous autothermal phase II. The temperature should not exceed 750° C. during the continuous, autothermal phase II since molybdenum goes over into the gas phase at these temperatures and would be blown out with the exhaust air during operation of the fluidized-bed furnace.

The process temperature is preferably kept in the preferred range from 630° C. to 730° C. in the continuous, autothermal phase II in a simple way via controlling the rate at which the material flows through the furnace. Here, it has been found to be advantageous for the flow rate of waste materials containing valuable metals through the furnace to be from 800 to 1200 kg/h, preferably from 900 to 1100 kg/h, particularly preferably about 1000 kg/h. This ensures that there is always enough fuel in the form of oil residues and carbon deposits adhering to the waste materials containing valuable metals in order to maintain the preferred process temperature. The introduction of an excess of material into the fluidized-bed furnace, which would lead to an undesirable increase in the process temperature to above the preferred range from 720 to 730° C., is likewise prevented by control of the flow of material through the furnace in the range indicated above. To control the flow rate of material, a continuously controlled weighing device, i.e. a differential metering balance, is installed upstream of the fluidized-bed furnace in a further embodiment of the invention. The structure and function of differential metering balances are known to a person skilled in the art. The amount of material introduced is controlled by means of the weighing device, with back-coupling with the process temperature in the fluidized-bed furnace and the fill level measuring device of the fluidized-bed furnace occurring.

In a preferred embodiment of the invention, the fill level of the waste materials containing valuable metals in the fluidized-bed furnace is kept in the range from 15 to 25%, preferably from 16% to 21%, during the continuous, autothermal phase II. The residence time of the material in the fluidized-bed furnace is thus, and taking into account the material flow rate indicated above, from about 3 to 4 hours. The fill level of the reactor is controlled by means of a differential pressure measurement, preferably in coregulation with the flow of material through the furnace. The coregulation of the fill level and the flow rate of material can be used particularly advantageously for the stable regulation of the process temperature in the preferred range from 630 to 730° C. The differential pressure measurement is described in more detail below in connection with the description of the fluidized-bed furnace of the invention.

To regulate the temperature, a plurality of temperature measuring points are provided in the fluidized-bed furnace and these are located both in the bed of material and also above the bed of material. Each temperature measuring point contains at least one temperature sensor. It has been found to be advantageous for the fluidized-bed furnace to be equipped with six temperature measuring points. Preference is given to two redundant measuring points always being present as a precaution against possible complete failure of the fluidized-bed furnace in the event of possible malfunctions at temperature sensors.

The process temperature in the range from 630° C. to 730° C. also has to be achieved and regulated in the bed of material in the interior of the fluidized-bed furnace. For this purpose, it has been found to be advantageous for the temperature of the bed of material also to be measured, for example at a plurality of measurement points, preferably at 2-5 measurement points, particularly preferably at two measurement points. In this embodiment, four temperature measurement points are located above the bed of material. If the process temperature in the bed of material changes, this can be regulated by controlling the flow rate of material. That is to say, when the process temperature in the bed of material drops, the flow rate of material and the amount of process air (oxidation air) introduced are increased. Conversely, the flow rate of material and the amount of process air introduced are decreased when the temperature in the bed of material rises above the intended range. Furthermore, the process temperature can be influenced via the temperature of the process air introduced, since the invention provides for the process air, as described below, to be able to be preheated.

To burn off the organic residues such as oil residues and carbon deposits which adhere to the waste materials containing valuable metals, the fluidized-bed furnace is supplied with process air. In the continuous, autothermal phase II, from about 3000 to 5000 kg/h of process air are fed into the fluidized-bed furnace. This amount of air has been found to be sufficient to burn off oil residues and the carbon deposits efficiently and essentially completely from the waste materials containing valuable metals. In a preferred embodiment of the process of the invention, the process air is preheated, particularly preferably to a temperature in the range from 45° C. to 130° C., before introduction into the fluidized-bed furnace. The air here is preferably preheated atmospheric air. In this way, weather-related temperature fluctuations can firstly be reacted to.

On the other hand, the preheating of the process air makes it possible to exert an additional influence, in addition to regulation of the fill level and the rate of flow of material through the fluidized-bed furnace, on the process temperature and in particular on the regulation thereof in the preferred range from 630 to 730° C. Preheating of the process air is carried out in a preheating device. Preheating the process air can be effected, for example, using the waste heat of the fluidized-bed furnace, i.e. the heat of the combustion air. For this purpose, conventional heat exchangers can be used.

In a preferred embodiment of the process of the invention, the fluidized-bed furnace is operated under reduced pressure, preferably at a pressure in the range from -0.2 to -0.3 mbar, during the continuous, autothermal phase II. This ensures that no harmful exhaust gases which arise from burning-off of the organic residues such as oil residues and carbon deposits and also of sulfur, which adhere to the waste materials containing valuable metals, can be emitted from the fluidized-bed furnace. At the same time, operation of the fluidized-bed furnace under reduced pressure serves as safety measure and for protection against explosion. Apart from these advantages mentioned, operation under reduced pressure also has economic advantages since all plant components can be made with lower thicknesses of material than would be necessary for operation under superatmospheric pressure. During the continuous introduction, the waste materials containing valuable metals are heated abruptly to the process temperature in the range from 630° C. to 730° C. in the fluidized-bed furnace. This leads to a sudden transition of volatile oil residues and volatile carbon constituents into the gas phase and these are directly burnt in the reactor space of the fluidized-bed furnace. Operation of the fluidized-bed furnace under reduced pressure prevents emission of highly explosive vapours into the atmosphere in the surroundings of the reactor. This mode of operation virtually rules out the risk of explosions during the continuous, autothermal phase II of the process of the invention. To measure the pressure, at least one pressure meter is present in the interior of the reactor. The subatmospheric pressure in the range from -0.2 to -0.3 mbar in the interior of the fluidized-bed furnace is preferably generated and regulated essentially by extraction of the exhaust gases. Further regulation of the internal pressure of the fluidized-bed furnace can optionally be effected by controlling the flow rate of material. That is to say, when the pressure in the fluidized-bed furnace rises to 1 bar or above, the introduction of material, for example, is stopped and no more material is fed in.

The waste materials containing valuable metals, for example catalyst batches from petroleum refineries which are to be reprocessed, can generally have a sticky consistency because of the oil residues present. Such batches of waste material therefore cannot be transported by means of conveyor belts, transport screws or the like since they lead to conglutination of the transport paths. In a further embodiment, the process of the invention therefore comprises a step of pretreatment of the batches of waste material containing valuable metals. This pretreatment can be carried out in a very simple way, for example by mixing with previously treated and dry materials until the resulting mixture no longer has sticky properties.

The process of the invention gives rise to exhaust gases which contain, inter alia, dust-like material, e.g. catalyst dust, which because of the mode of operation in the fluidized-bed furnace is discharged, and sulfur, mainly in the form of sulfur oxides such as SO₂ and SO₃. For reasons of environmental protection, these materials should if possible be prevented from getting into the environment. In a further embodiment, the process of the invention therefore comprises a step of exhaust gas purification. To remove dust-like materials from the exhaust gas stream, the exhaust gas stream is filtered. Filtration of the exhaust gases is carried out using commercial filters, for example coarse and fine filters. Suitable coarse and fine filters consist of, for example, stainless steel. The process of the invention is particularly environmentally friendly since the dust-like material which is removed from the exhaust gas stream by means of the filters can be added directly to the finished product.

To remove the sulfur, i.e. the sulfur oxides, the exhaust gas stream is scrubbed. In a preferred embodiment, the scrubbing of the exhaust gas stream comprises a plurality of scrubbing stages in which scrubbing is carried out using water and milk of lime. Scrubbing with water serves to separate off amounts of dust remaining in the exhaust gas stream. Scrubbing with milk of lime serves to remove sulfur oxides from the exhaust gas stream, with the sulfur oxides being reacted with the milk of lime to form gypsum. To assist the removal of the sulfur oxides, an additional scrub of the exhaust gas stream using sodium hydroxide solution is carried out in a particularly preferred embodiment of the exhaust gas purification.

As indicated above, the process of the invention, in particular the phase II of continuous reprocessing of waste materials containing valuable metals, is particularly energy-efficient since it proceeds autothermally and is particularly environmentally friendly since the emission of pollutants into the environment is prevented and the waste heat of the process is utilized for preheating the process air. In addition, the invention makes a significant contribution to reducing the CO₂ footprint of the branches of industry concerned and closes, as part of circular economics, the materials circuit for the valuable metals mentioned.

Only in the start-up phase I does energy have to be supplied to the fluidized-bed furnace in order to attain the process temperature in the range of 630° C.-730° C.

If exclusively untreated waste materials containing valuable metals have been used for the first-time filling of the fluidized-bed furnace in the start-up phase, this could lead to conglutination of the material and subsequent sintering when heat is applied. This would have an adverse effect on the start-up process. In order to prevent this, the fluidized-bed furnace is firstly filled with previously reprocessed material, which in particular no longer contains any oil residues and no sulfur residues, for start-up. This is important since not too much fuel may be present in the fluidized-bed furnace on first-time ignition of the process, because this could lead to an explosion. In one example, it has been found to be advantageous for the fluidized-bed furnace firstly to be charged with a proportion of previously reprocessed material, preferably about 10% of the fill level. To start the fluidization of the material in the fluidized-bed furnace, blowing process air, which has preferably been preheated, into the fluidized-bed furnace is commenced simultaneously with the introduction of the previously treated material. The blowing of the process air into the fluidized-bed furnace is preferably effected from below. The heating of the fluidized-bed furnace, in particular of the material which has already been introduced into the fluidized-bed furnace, is carried out approximately simultaneously. The heating is preferably effected by means of at least one, preferably two, particularly preferably three, gas burner(s), for example on the basis of natural gas. Introduction of “untreated” waste materials containing valuable metals is then commenced. The ignition of the reaction, i.e. the burning-off of the oil and sulfur residues, is then carried out for the first time using a separate burner, the ignition burner. When the process temperature (630° C.-730° C.) has been attained, all burners, including the ignition burner, are switched off and the process from then on proceeds continuously and autothermally. This effects the transition of the process into phase II.

In a preferred embodiment, the process of the invention comprises, in the phase I of start-up of the fluidized-bed furnace, the steps:
i) Introduction of previously reprocessed material into the fluidized-bed furnace while simultaneously blowing process air into the fluidized-bed furnace and fluidization of the material,
ii) Heating of the fluidized-bed furnace to the process temperature using at least one, preferably two, particularly preferably three, gas burner(s),
iii) Introduction of waste materials containing valuable metals,
iv) Ignition of the reaction using an ignition burner,
v) Switching-off of all burners when the process temperature of from 630° C. to 730° C. has been reached.

The ignition burner is no longer required during the course of the further process, i.e. in the continuous, autothermal phase II, and can therefore be taken from the process.

The continuous, autothermal phase II can now be operated for a number of months or a number of years. The time-on-stream is limited merely by wear of plant parts of the fluidized-bed furnace. Necessary maintenance and replacement of constituents of the fluidized-bed furnace would then lead to shutting-down of the fluidized-bed furnace. After repair or maintenance has been completed, the fluidized-bed furnace would then have to be started up again according to the steps of phase I. Relatively minor repairs, which lead to only short interruptions of the continuous, autothermal phase II, can be carried out without the fluidized-bed furnace having to be restarted. The process of the invention and the fluidized-bed furnace of the invention have the further advantage that the temperature in the material present in the fluidized-bed furnace (15% to 25% fill level, see above) is maintained for about 2-3 days when the process is stopped or interrupted.

The discharge of the burned-off batches of material, which no longer contain oil and sulfur residues, is effected at the lower end of the fluidized-bed furnace, with the rate of discharge of the material being regulated, like the feed rate of material, in conjunction with the control of the fill level. The discharge of material is preferably effected under the action of gravity by means of a discharge apparatus.

In a further embodiment, the process of the invention can comprise steps for after-treatment of the discharged material. For example, an after-treatment in a rotary tube furnace can be carried out according to specific customer wishes.

However, the material is usually discharged into a stock vessel from where the material is transported further by means of transport devices, for example a cooling transport screw and pneumatic transport devices, to a packaging facility for Big Bags.

In a further aspect, the invention provides an apparatus for carrying out the process of the invention for recycling waste materials containing valuable metals, in particular catalyst batches from petroleum refineries. As central element, this apparatus comprises a fluidized-bed furnace in which the reprocessing of the waste materials containing valuable metals is carried out. The fluidized-bed furnace is configured so that the reprocessing of the waste materials can be carried out in a continuous and autothermal process.

In one embodiment, the fluidized-bed furnace of the invention comprises the following constituents:
a steel vessel having a refractory lining,
an inlet for waste materials containing valuable metals,
at least one outlet for discharge of material (product),
at least one inlet for introduction of process air and
a fill level measuring device,
at least one pressure meter for the reactor interior (reactor operates under a reduced pressure of from -0.2 to -0.3 mbar),
at least one temperature sensor, preferably a plurality of temperatures sensors, particularly preferably six temperature sensors, with two measurement points being distributed in the bed of material.

The steel vessel of the fluidized-bed furnace comprises a refractory lining customary in the field. The inlet for the waste materials containing valuable metals is preferably arranged in the upper third, particularly preferably in the upper quarter, of the fluidized-bed furnace. In this way, the waste materials introduced are fluidized immediately after introduction into the fluidized-bed furnace by the process air blown in from below. Settling of the waste materials after introduction into the fluidized-bed furnace is thus prevented.

The fluidized-bed furnace has at least one outlet, preferably a plurality of outlets, particularly preferably two outlets, for discharge of the material, i.e. for discharge of the waste material which has been burnt off and freed of oil and sulfur residues. The outlet or outlets for the discharge of material are, in a preferred embodiment of the fluidized-bed furnace of the invention, arranged at the lower end of the fluidized-bed furnace so that the discharge of material can be carried out in a simple way by means of gravity via a material discharge apparatus. The discharge of material is regulated by control of flaps which are arranged in the outlets for the discharge of material.

The process air is blown in via at least one inlet, preferably from below, into the fluidized-bed furnace. To achieve the desired fluidization of the waste materials containing valuable metals, the fluidized-bed furnace of the invention further comprises an air distributor for distributing the process air which is fed in via the at least one inlet. The air distributor is preferably arranged in the lower region of the fluidized-bed furnace. In order to optimize the fluidization by means of air further, the air distributor can additionally have air nozzles.

The rate of introduction of the waste materials containing valuable metals and the rate of discharge of material, i.e. overall the flow rate of material through the furnace, are controlled by means of a fill level measuring device in the fluidized-bed furnace of the invention. In a preferred embodiment, the fluidized-bed furnace of the invention therefore comprises a fill level measuring device which operates reliably at the high process temperatures in the range of 630° C. - 730° C. and the reduced pressure in the range from -0.2 to -0.3 mbar prevailing in the fluidized-bed furnace. In a particularly preferred embodiment, the fill level measuring device is based on a differential pressure measurement between two measurement points of which one measurement point, i.e. a first pressure sensor, is arranged above the bed of material and one measurement point, i.e. a second pressure sensor, is arranged below the bed of material. To increase the reliability and measurement certainty, this differential pressure measurement is configured in a redundant manner in a preferred embodiment of the invention. The fill level measuring device is configured so that the fill level of the fluidized-bed furnace is calculated with the aid of the differential pressure measurement, but preferably taking into account the temperature prevailing in the fluidized-bed furnace and the pressure prevailing in the fluidized-bed furnace. As already indicated above in connection with the process of the invention, it has been found to be advantageous for the fill level of the fluidized-bed furnace to be kept in the range from 15% to 25%.

As has likewise been mentioned above in connection with the process of the invention, the fluidized-bed furnace is operated at a reduced pressure, i.e. at a pressure in the range from -0.2 to -0.3 mbar. To measure the pressure in the interior, the fluidized-bed furnace has at least one pressure meter. The generation of the reduced pressure is effected by extraction of the process ir. In a further embodiment, the fluidized-bed furnace of the invention therefore has an extraction device for the process air.

As has likewise been mentioned above, it has been found to be advantageous for the temperature in the bed of material to be kept in the range from 630° C. to 730° C. For reliable temperature monitoring, the fluidized-bed furnace of the invention therefore has at least one temperature sensor, preferably a plurality of temperature sensors, particularly preferably six temperature sensors, with four measurement points preferably being arranged above the bed of material in order to measure the temperature of the gas phase and two measurement points being distributed vertically in the bed of material. In a particularly preferred embodiment, there are always two redundant measurement points as a precaution against a possible complete failure of the fluidized-bed furnace in the event of possible malfunctions at temperature sensors.

In a further embodiment, the apparatus of the invention comprises a preheating device for preheating the process air. For maintaining the temperature of the process air in the fluidized-bed furnace, it has been found to be advantageous for the process air to be preheated to 45° C. -130° C. The preheating of the process air before blowing into the fluidized-bed furnace is carried out advantageously in energy terms by means of a heat exchanger which is likewise a constituent of a further embodiment of the apparatus of the invention. The heat necessary for preheating the process air is obtained here from the exhaust air or the exhaust gas of the fluidized-bed furnace.

The exhaust gas, also referred to as exhaust air or flue gas, is extracted via an exhaust gas outlet which is located at the upper end of the fluidized-bed furnace.

The fluidized-bed furnace of the invention further comprises a control device in a particularly preferred embodiment. The control device is, in particular, configured for ensuring the autothermal mode of operation of the continuous phase II of the process of the invention. For this purpose, the fill level measuring device of the fluidized-bed furnace is controlled by the control device in such a way that the fill level of the fluidized-bed furnace is kept in the range from 15% to 25% by means of the differential pressure measurement of the fluidized-bed furnace and taking into account the high process temperatures of from 630° C. to 730° C. and also the pressure of from -0.2 to -0.3 mbar prevailing in the fluidized-bed furnace. The regulation of the fill level is effected via control of the rate of material inflow and the rate of discharge of material, thus overall the rate of flow of material through the furnace, with the discharge of material being effected under gravity by control of flaps in the at least one reactor having a material outlet. Control of the inflow rate of material is carried out, inter alia, using a differential metering balance which is arranged in the material introduction region of the apparatus of the invention and is coupled with the fill level measuring device and temperature measurement of the process temperature.

The control device is also configured for keeping the process temperature in the range from 630° C. to 730° C., which is achieved firstly by controlling the rate of material inflow and the rate of discharge of material and secondly by preheating the process air to a temperature in the range of 45° C. - 130° C. by means of the preheating device.

The control device is also configured for maintaining the pressure in the interior of the fluidized-bed furnace in the range from -0.2 to -0.3 mbar. For this purpose, the control device interacts with at least one pressure sensor which is arranged in the interior of the fluidized-bed furnace and an extraction apparatus in the exhaust gas stream of the fluidized-bed furnace.

In an embodiment of the invention, the control device is a PC, a tablet, a process computer or another data processing appliance, particularly preferably a fail-safe control device (SPS). The fail-safe control device is connected via conventional means for data transmission to the apparatus of the invention.

In further embodiments, the apparatus of the invention comprises, for carrying out the continuous autothermal phase II of the process of the invention, one or more auxiliary and additional devices selected for example from among
a differential metering balance in the material feed region, which is coupled with the fill level measuring device and the temperature measuring device for the process temperature and is controlled for regulating the rate of introduction of the material into the fluidized-bed furnace,
means for transporting the discharged treated material further, for example comprising a cooling transport screw, a pneumatic transport device and a packaging device for Big Bags,
optionally a rotary tube furnace for calcining and/or further processing of the product according to customer wishes,
an exhaust gas purification system, for example comprising
   at least one coarse filter and at least one fine filter for separating off dust-like material and recirculating it to the reprocessing process,
   a plurality of scrubbing stages for desulfurizing the exhaust gas stream, for example a scrubbing stage using water and two scrubbing stages using milk of lime,
   optionally an additional stage for scrubbing the exhaust gas stream with dilute sodium hydroxide solution,
one or more explosion flaps in the exhaust gas system to protect the fluidized-bed furnace against overpressure, and
a heat exchanger for cooling the exhaust air in the exhaust gas stream and for simultaneously preheating the process air to from 45 to 130° C.

For the phase I of start-up, the fluidized-bed furnace of the invention has at least one gas burner, preferably two gas burners, particularly preferably three gas burners, which are operated only for heating the fluidized-bed furnace during start-up. The gas burners can, for example, be operated using natural gas. To ensure efficient and uniform heating of the interior of the fluidized-bed furnace during the start-up phase, the three gas burners are, in an exemplary embodiment, arranged uniformly, i.e. arranged at a spacing of 120° over the cross section of the fluidized-bed furnace. The gas burners are also arranged in the upper third of the fluidized-bed furnace, so that heat input occurs from above into the bed of material during heating up of the fluidized-bed furnace. The feed conduits which convey the hot air generated by the gas burners and project into the interior of the fluidized-bed furnace are, in a preferred embodiment, arranged so that the air enters in a downward direction at an angle, for example of 45°, to the wall of the steel vessel. In this way, it is possible to ensure that the interior of the fluidized-bed furnace and in particular the masonry lining is heated uniformly by the bed formed by the waste materials containing valuable metals during start-up of the fluidized-bed furnace.

During the phase I of start-up of the fluidized-bed furnace, the burning-off of the oil and sulfur residues from the waste materials containing valuable metals has to be initiated. For this purpose, the apparatus of the invention, in particular the fluidized-bed furnace of the invention, has an ignition burner in a further embodiment. The ignition burner is likewise preferably operated using natural gas. This ignition burner serves for one-off ignition of the reaction in the fluidized-bed furnace, by means of which firstly the fluidized-bed furnace and the bed of material are heated to the process temperature of 630° C.-730° C. and, after attainment of this process temperature, the continuous autothermal phase II of the process for recycling waste materials containing valuable metals is started. After the treatment of the waste materials has gone over into the continuous autothermal phase II, the ignition burner is no longer needed and is preferably taken from the process.

The fluidized-bed furnace of the apparatus of the invention can optionally have additional reserve points for the introduction and discharge of air, product, exhaust gas, etc.

As an example of waste materials treated, mention may be made of catalyst materials from the petroleum industry. These contain about 80% of aluminium oxide, about 12% of molybdenum and about 8% of nickel and/or cobalt and are popular additives in the steel industry and the like, for example as flux, slag former or as constituent of steel alloys. In a further aspect, the invention therefore provides for the use of the waste materials which have been treated by the process of the invention in the steel industry and fine chemicals production.

The invention will be explained in more detail below with the aid of four drawings.

### THE DRAWINGS SHOW

FIG. 1 a process diagram to illustrate the start-up phase I;

FIG. 2 a process diagram to illustrate the continuous, autothermal phase II;

FIG. 3 a longitudinal section through the fluidized-bed furnace according to the invention;

FIG. 4 a cross section through the reactor to depict the arrangement of the burners;

FIG. 5 a cross section through the reactor to depict an alternative configuration of the arrangement of the burners.

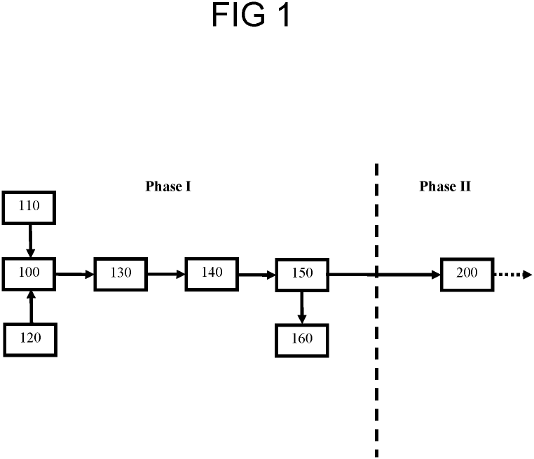

FIG. 1 shows a process flow diagram to illustrate the phase I of start-up of the fluidized-bed furnace according to the invention. The start-up phase of the fluidized-bed furnace can be described as follows:

100 For start-up, the fluidized-bed furnace is firstly filled with about 1.5 t of previously reprocessed material which no longer contains, in particular, any oil residues and sulfur residues. If exclusively untreated waste materials were utilized for first-time filling of the fluidized-bed furnace in the start-up phase, this could lead to conglutination of the materials and to subsequent sintering when heat is applied. This would have an adverse effect on the start-up process. The initial filling with previously reprocessed waste materials is also important because not too much fuel may be present in the fluidized-bed furnace during one-off ignition of the process, which would lead to uncontrolled evolution of heat.

110 At the same time as step 100, heating of the fluidized-bed furnace, in particular of the previously treated waste materials which have been introduced into the fluidized-bed furnace, occurs. Heating is preferably effected using at least one, preferably two, particularly preferably three, gas burner(s) on the basis of natural gas.

120 To start the fluidization of the material in the fluidized-bed furnace, the blowing of process air, which has preferably been preheated to from 45 to 130° C., into the fluidized-bed furnace is commenced simultaneously with commencement of the introduction of the previously treated waste materials in step 100. The process air is preferably blown into the fluidized-bed furnace from below.

130 The introduction of “untreated” waste materials containing valuable metals is then commenced.

140 After commencement of the introduction of the untreated waste materials containing valuable metals, the reaction, i.e. the burning-off of the oil and sulfur residues, is then ignited once using a separate burner, the ignition burner.

150 When the process temperature (from 630° C. to 730° C.) has been reached, all burners, including the ignition burner, are switched off and the process goes over into phase II, i.e. the process from then proceeds continuously and autothermally 200.

160 After successful conclusion of the start-up phase I, the ignition burner is taken out of the process. The process from then proceeds continuously and autothermally 200 over many months up to a number of years. The process has to be interrupted only when maintenance or repair is necessary on the fluidized-bed furnace because of material wear. Maintenance which can be carried out within 2 to 3 days does not require a renewed start-up phase I; although the process temperature in the bed of the material does drop over this period of time, it is always still sufficiently high for continuation of the continuous phase II. After conclusion of any such brief maintenance or repair, the continuous and autothermal operation of the fluidized-bed furnace can therefore be continued directly.

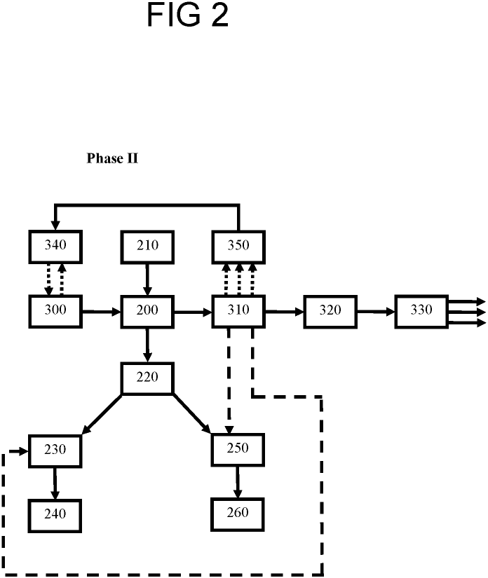

FIG. 2 shows a flow diagram to illustrate the continuous, autothermal phase II 200 for recycling of waste materials containing valuable metals in the fluidized-bed furnace of the invention. The continuous, autothermal phase II 200 can be described as follows:

200 denotes the continuous, autothermal phase II in the fluidized-bed furnace. The special aspect of phase II is that no more heat apart from the preheating of the process air has to be introduced into the fluidized-bed furnace after the one-off ignition. A sufficient amount of sulfur and carbon compounds adhere to the waste materials containing valuable metals for there to be sufficient fuel in the system to keep the process temperature in the range from 630° C. to 730° C.

In this example, catalyst materials from the petroleum industry were used as waste materials containing valuable metals. These contained about 80% of aluminium oxide, about 12% of molybdenum and about 8% of nickel and/or cobalt. The catalyst batches also contained three particle size fractions: dust, larger fragments and a fraction comprising intact catalyst particles. Main impurities after use of the catalyst batches in petroleum refining processes are oil residues and sulfur.

The continuous, autothermal phase II in the fluidized-bed furnace is characterized by the following process parameters:
Reactor temperature: 630° C.-730° C.
Process air: 45-130° C., 3000 to 5000 kg/h
Flow rate of material through the furnace: about 1000 kg/h
Residence time of the material: about 4 h
Fill level of the reactor: 15% to 25%
Pressure in the reactor: -0.2 to -0.3 mbar

210 symbolizes the introduction of waste materials containing valuable metals, which takes place in the upper part of the fluidized-bed furnace. The process temperature is kept in the preferred range from 630° C. to 730° C. during the continuous, autothermal phase II, preferably in a simple way via control of the flow rate of material through the furnace. The flow rate of waste materials containing valuable metals which are to be treated is in the range from 800 to 1200 kg/h, preferably from 900 to 1100 kg/h, particularly preferably about 1000 kg/h. To control the inflow rate of material, the fluidized-bed furnace is preceded by a differential metering balance. The amount of material introduced is regulated by means of an SPS which controls the differential metering balance, with back-coupling being effected with the process temperature in the fluidized-bed furnace and the fill level measuring device of the fluidized-bed furnace.

If the temperature in the bed of material drops below the intended range, the inflow rate of material is increased. Conversely, the inflow rate of material is decreased when the temperature in the bed of material rises above the intended range.

220 The discharge of the treated material occurs at the lower end of the fluidized-bed furnace under gravity by means of a discharge apparatus which contains controllable flaps.

230, 240 After exit from the fluidized-bed furnace, the treated material can be processed further depending on customer wishes, for example in a rotary tube furnace 230. The material which has been treated further in this way is then packed 240 for delivery to customers.

250 However, the material is usually discharged into a stock vessel from where it is transported away via transport devices, for example a cooling transport screw and pneumatic transport devices, to a packaging facility for Big Bags.

260 symbolizes dispensing into Big Bags.

300 symbolizes the introduction of process air. To burn off organic residues such as oil residues and carbon deposits which adhere to the waste materials containing valuable metals, the fluidized-bed furnace is supplied with from about 3000 to 5000 kg/h of process air in the continuous, autothermal phase II. This amount of air has been found to be sufficient to burn off oil residues and the carbon deposits efficiently and essentially completely from the waste materials containing valuable metals. The process air is ideally preheated to a temperature in the range from 45° C. to 130° C. before introduction into the fluidized-bed furnace. This process air is preheated atmospheric air. To preheat the process air, it is possible to utilize, for example, the waste heat of the fluidized-bed furnace, i.e. the heat of the filtered combustion air 310, with preheating being carried out in a heat exchanger 340. The heat exchange for preheating the process air 300 is symbolized by the dotted arrows between 300 and 340. Hot steam 350 is used for preheating the process air 300. The hot steam 350 is produced by heating water by means of the filtered exhaust air described in the following stage 310.

310 Exhaust gases which contain, inter alia, dust-like material, which owing to the mode of operation is discharged from the fluidized-bed furnace, and sulfur, mainly in the form of sulfur oxides such as SO₂ and SO₃, arise in the process of the invention. For reasons of environmental protection, the emission of these materials into the environment should be avoided if possible. 310 symbolizes the first step of exhaust gas purification. To remove the dust-like materials from the exhaust gas stream, the exhaust gas stream is filtered. Filtering of the exhaust gases is carried out using commercial filters, preferably using coarse filters and fine filters. Suitable coarse and fine filters consist, for example, of stainless steel. The process of the invention is particularly environmentally friendly since the dust-like materials which are removed from the exhaust gas stream by means of the coarse and fine filters are directly added to the treated product (symbolized by the broken line between 310 and 250 or between 310 and 230).

320 To remove the sulfur, i.e. the sulfur oxides, the exhaust gas stream is scrubbed. Scrubbing of the exhaust gas stream generally comprises a plurality of scrubbing stages, with scrubbing being carried out using water and milk of lime. The scrubbing with water serves to remove residual portions of dust in the exhaust gas stream. Scrubbing with milk of lime serves to separate sulfur oxides from the exhaust gas stream, with the sulfur oxides being reacted with the milk of lime to form gypsum. To assist the removal of the sulfur oxides, an additional scrub of the exhaust gas stream using sodium hydroxide solution can be carried out in a further scrubbing stage.

330 symbolizes the purified and cooled combustion air which is discharged into the atmosphere.

350 symbolizes hot steam which is produced by heating water by means of the filtered exhaust air described in step 310. The hot steam is utilized in the process of the invention in order to preheat the process air 300 in the heat exchanger 340.

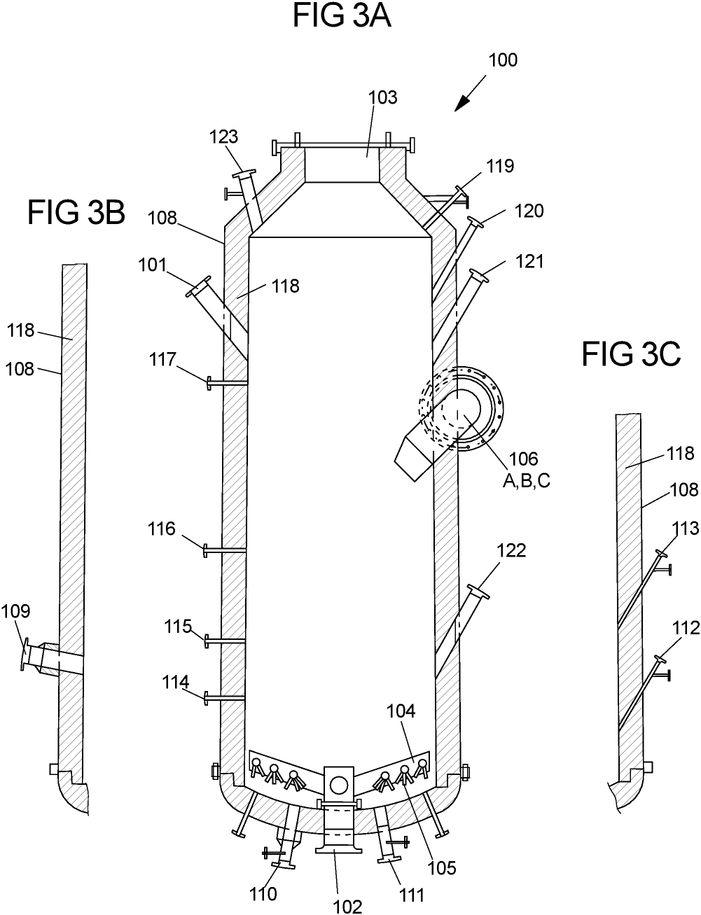

FIG. 3A shows a schematic depiction of the fluidized-bed furnace 100 of the apparatus of the invention. The fluidized-bed furnace 100 comprises a steel vessel 108 having a refractory lining 118. Introduction of the waste materials containing valuable metals during the continuous, autothermal phase II is carried out via the material inlet 101. In the start-up phase I, prefilling with previously treated material is also carried out via the material inlet 101. The discharge of the treated material is effected at the lower end of the steel vessel 108 under gravity via the material outlets 110 and 111. Discharge apparatuses with integrated flaps for controlling the rate of discharge of material can be arranged at the material outlets 110 and 111.

The introduction of the process air 102, which has preferably been preheated, is effected at the lower end of the steel vessel 108. To obtain better distribution of the process air and optimal fluidization of the waste materials containing valuable metals, the process air is blown into the steel vessel 108 via an air distributor 104 having a plurality of air nozzles 105. The outlet 103 for the exhaust gases or the combustion air is located at the upper end of the steel vessel 108.

The rate of introduction of the waste materials containing valuable metals and the rate of discharge of material are controlled with the aid of a fill level measuring device in the fluidized-bed furnace 100. For this purpose, the fluidized-bed furnace comprises a fill level measuring device which operates reliably at the high process temperatures in the range from 630° C. to 730° C. and the reduced pressure in the range from -0.2 to -0.3 mbar prevailing in the steel vessel. The fill level measuring device operates on the basis of a differential pressure measurement between two measurement points 112, 113, of which one measurement point, i.e. a first pressure sensor 113, is arranged above the bed of material in the steel vessel 108 of the fluidized-bed furnace 100 and one measurement point, i.e. a second pressure sensor 112, is arranged below this bed of material. To increase the reliability and measurement certainty, this differential pressure measurement is configured redundantly. The fill level measuring device is configured so that the fill level in the steel vessel is calculated with the aid of the differential pressure measurement, but preferably taking into account the temperature prevailing in the steel vessel and the pressure prevailing in the steel vessel. The fill level in the steel vessel 108 is kept in the range from 15% to 25%, preferably from 16% to 21%.

The process temperature is kept in the range from 630° C. to 730° C. in the bed of material. For reliable temperature monitoring, the fluidized-bed furnace 100 therefore has at least one temperature sensor, preferably a plurality of temperature sensors, particularly preferably six temperature sensors 114, 115 and 116, with at least two measurement points preferably being distributed vertically over the bed of material. In addition, the fluidized-bed furnace 100 can have further temperature sensors, for example the temperature sensor 117, which measure the temperature above the bed of material within the steel vessel 108.

The fluidized-bed furnace 100 is operated under reduced pressure, preferably at a pressure in the range from -0.2 to -0.3 mbar, during the continuous, autothermal phase II. To measure the pressure, at least one pressure meter 119 is present in the interior of the fluidized-bed furnace. The reduced pressure in the interior of the fluidized-bed furnace in the range from -0.2 to -0.3 mbar is generated and regulated by, inter alia, extraction of the exhaust gases via the outlet 103.

During the start-up phase I, the fluidized-bed furnace 100 is heated by the three burners 106A, 106B and 106C until the operating temperature in the range from 630° C. to 730° C. has been reached in the steel vessel 108. It can be seen in FIG. 3A that the three burners are arranged via the inlets 106A, 106B and 106C in the upper third of the steel vessel 108. The inlet tubes of the three burners 106A, 106B and 106C are, in the embodiment shown here, arranged so that the air inflow stream is at an angle of 45° relative to the wall of the steel vessel 108. Other possible ways of arranging the inlet tubes are likewise conceivable.

The apparatus of the invention can contain, in addition to the fluidized-bed furnace 100, one or more auxiliary and additional devices selected from among
a differential metering balance in the material feed region (coupled with the fill level measuring device and the temperature measurement of the process temperature),
a means for transporting the discharged treated material further, for example comprising a cooling transport screw, a pneumatic transport device and a packaging device for Big Bags,
optionally a rotary tube furnace for calcining and/or further processing the product,
an exhaust gas purification system, for example comprising
   at least one coarse filter and at least one fine filter for separating off dust-like material and discharging it into the product stream,
   a plurality of scrubbing stages for desulfurizing (to form gypsum) the exhaust gas stream, for example a scrubbing stage using water and two scrubbing stages using milk of lime,
   optionally an additional stage for scrubbing the exhaust gas stream with dilute sodium hydroxide solution,
one or more explosion flaps in the exhaust gas system to protect against overpressure,
a heat exchanger for cooling the exhaust air in the exhaust gas stream, with the waste heat being utilized for preheating the process air.

Furthermore, the apparatus of the invention comprises a control device for controlling the fluidized-bed furnace 100 during the continuous, autothermal phase II, which is configured for
controlling the fill level measuring device so that the fill level of the steel vessel 108 is kept in the range from about 15% to 25%, preferably from 16% to 21%, by means of the differential pressure measurement 112, 113 and taking into account the high process temperatures of from 630° C. to 730° C., with the discharge of material being effected under gravity by control of the flap in the material outlets 110 and 111;
and/or keeping the process temperature in the range from 630° C. to 730° C., with the process air being preheated to a temperature in the range of 45° C. - 130° C. by means of the heat exchanger,
and/or setting the pressure in the interior of the steel vessel 108 of the fluidized-bed furnace 100 in the range from -0.2 to -0.3 mbar.

The fluidized-bed furnace 100 according to the invention can further comprise reserve ports 120, 121, 122 and also a sight glass 123 with flushing connection for visual process monitoring.

FIG. 3B shows a section of the wall of the fluidized-bed furnace 100 with the steel vessel 108 which has the connection 109 of the ignition burner for starting up the fluidized-bed furnace in phase I. The ignition burner is taken from the process after successful conclusion of the start-up phase I.

FIG. 3C shows a section of the wall of the fluidized-bed furnace 100 with the steel vessel 108, which has the lower pressure sensor 112 and the upper pressure sensor 113 for the differential pressure measurement as a basis for the fill level measuring device of the apparatus of the invention.

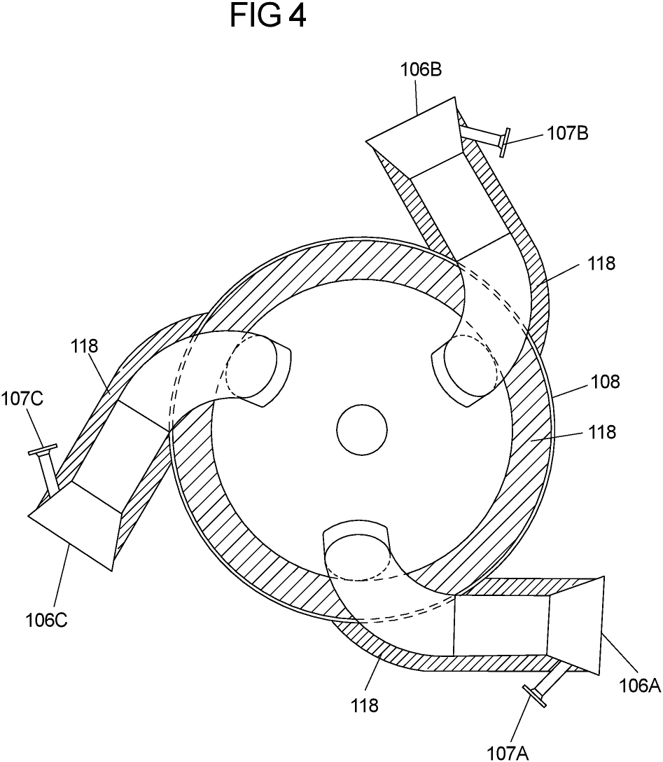

FIG. 4 shows a cross section through the fluidized-bed furnace 100 with the three burners 106A, 106B and 106C which are operated using natural gas for heating the steel vessel 108 during the start-up phase I until the process temperature in the range from 630° C. to 730° C. has been attained. The three burners 106A, 106B and 106C are arranged at a spacing of in each case 120° around the circumference of the steel vessel 108. The burner inlets 106A, 106B and 106C contain steel tubes which are surrounded by a refractory coating 118.

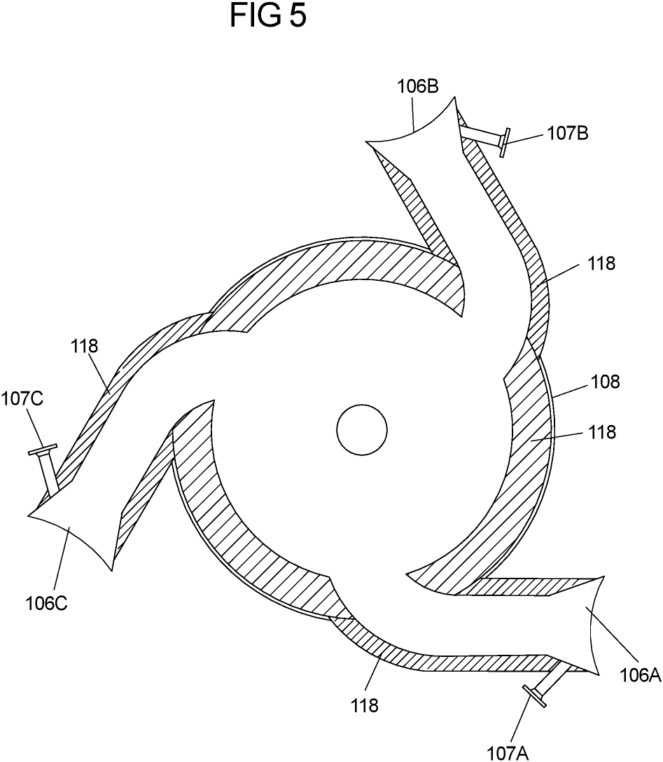

FIG. 5 shows a cross section through the fluidized-bed furnace 100 with the three burner inlets 106A, 106B and 106C which are operated using natural gas for heating the steel vessel 108 during the start-up phase I until the process temperature in the range from 630° C. to 730° C. has been attained. The three burner inlets 106A, 106B and 106C are arranged at a spacing of in each case 120° around the circumference of the steel vessel 108. In the embodiment shown here, the burner inlets 106A, 106B and 106C consist entirely of refractory materials 118 and do not contain any steel tubes.

List of reference numerals

| | |
|---|---|
| 100 | Fluidized-bed furnace |
| 101 | Inlet for introduction of material |
| 102 | Inlet for process air |
| 103 | Outlet for exhaust air |
| 104 | Air distributor |
| 105 | Air nozzles |
| 106A, B, C | Burners |
| 107A, B, C | Sight glass for burner |
| 108 | Steel vessel |
| 109 | Ignition burner connection |
| 110, 111 | Outlet for material |
| 112 | Lower pressure meter for fill level measuring device |
| 113 | Upper pressure meter for fill level measuring device |
| 114, 115, 116 | Temperature meter in the bed of material |
| 117 | Temperature meter above the bed of material |
| 118 | Refractory lining or coating |
| 119 | Pressure sensor |
| 120, 121, 122 | Reserve ports |
| 123 | Sight glass with flushing connection |

1. Process for reprocessing waste materials containing valuable metals in a fluidized-bed furnace (100), comprising the phases:
I. Start-up of the fluidized-bed furnace (100); and
II. Continuous reprocessing of the waste materials,
wherein the fluidized-bed furnace (100) is operated autothermally during the phase II of continuous reprocessing of the waste materials containing valuable metals, and reprocessing temperature in the fluidized-bed furnace (100) is regulated by the fill level in the fluidized-bed furnace (100) and the flow rate of material through the fluidized-bed furnace.

2. Process according to claim 1, characterized in that the temperature in the fluidized-bed furnace (100) during the continuous, autothermal phase II is kept in the range of 630° C. to 730° C.

3. Process according to claim 1 wherein the fluidized-bed furnace (100) is operated at a flow rate of material through the furnace of about 1000 kg/h during the continuous, autothermal phase II.

4. Process according to claim 1 wherein the fill level in the fluidized-bed furnace (100) in the continuous, autothermal phase II is kept in the range from 15% to 25%, controlled by a pressure differential measurement.

5. Process according to claim 1 wherein about 3000 to 5000 kg/h of process air, preheated to a temperature in the range from 45° C. to 130° C., is are introduced into the fluidized-bed furnace (100) during the continuous, autothermal phase II.

6. Process according to claim 1 wherein residence time of the waste materials containing valuable metals in the fluidized-bed furnace (100) during the continuous, autothermal phase II is about 4 hours.

7. Process according to claim 1 wherein the fluidized-bed furnace (100) is operated under reduced pressure, during the continuous, autothermal phase II.

8. Process according to claim 1 wherein the phase I start-up of the fluidized-bed furnace (100) comprises the steps:
i) Introduction of previously reprocessed material into the fluidized-bed furnace while simultaneously blowing process air into the fluidized-bed furnace and fluidizing the material,
ii) Heating of the fluidized-bed furnace to a reprocessing temperature using at least one gas burner,
iii) Introduction of waste materials containing valuable metals,
iv) Ignition of the reaction using an ignition burner,
v) Switching-off of said at least one gas burner when the reprocessing temperature reaches 630° C. to 730° C.

9. Process according to claim 8 wherein the ignition burner is removed after completion of the phase I of start-up of the fluidized-bed furnace (100).

10. Apparatus for recycling waste materials containing valuable metals in a continuous autothermal process, comprising a fluidized-bed furnace (100) which comprises
a steel vessel (108) having a refractory lining (118), an inlet (101) for waste materials containing valuable metals, at least one outlet for discharge of material (110, 111), and at least one inlet for introduction of process air (102),
a preheating device for preheating the process air to a temperature in the range of 45° C. –130° C.,
at least one gas burner operated only for heating the fluidized-bed furnace (100) to temperature in the range of 720° C. to 730° C. during start-up,
a fill level measuring device, preferably based on a differential pressure measurement between two measurement points (112, 113), of which one measurement point (113) is arranged above the bed of material and one measurement point (112) is arranged below the bed of material,
at least one pressure meter (119) for measuring the pressure within the steel vessel (108), and
at least one temperature sensor for measuring temperature in the fluidized-bed furnace (100).

11. Apparatus according to claim 10, characterized in that the at least one outlet (110, 111) for discharging material from the fluidized-bed furnace (100) has a flap for controlling the rate of discharge of material.

12. The apparatus according to claim 10 wherein the fluidized-bed furnace (100) further includes an air distributor (104) with air nozzles (105) for distributing the process air which is fed via the at least one inlet (102) into the fluidized-bed furnace (100).

13. The apparatus according to claim 10 characterized in that the fluidized-bed furnace (100) further includes an ignition burner (109) for one-off ignition/starting of the continuous, autothermal process phase II for recycling waste materials containing valuable metals.

14. The apparatus according to claim 10 further comprising a control device which is configured for
controlling the fill level measuring device so that the fill level of the steel vessel (108) is kept in the range from 15% to 25% by means of the differential pressure measurement using the pressure sensors (112, 113) and taking into account the process temperatures of from 630° C. to 730° C., with the discharge of material being effected under gravity by control of the flap in the at least one outlet (110, 111);
and/or keeping the process temperature in the range from 630° C. to 730° C., with the process air being preheated to a temperature in the range of 45° C. – 130° C. by means of the preheating device,
and/or setting the pressure in the interior of the steel vessel to a value in the range from -0.2 to -0.3 mbar by control of an extraction device for the exhaust gases.

15. The apparatus according to claim 10 further comprising at least one auxiliary device selected from the group consisting of
a differential metering balance in the material feed region, which is coupled with the fill level measuring device and the temperature measurement of the process temperature,
a means for transporting the discharged treated material further,
an exhaust gas purification system comprising
at least one fine filter for separating off dust-like material and discharging it into the product stream,
a plurality of scrubbing stages for desulfurizing the exhaust gas stream, for example a scrubbing stage using water and two scrubbing stages using milk of lime,
at least one explosion flap in the exhaust gas system to protect against overpressure, and
a heat exchanger for cooling the exhaust air in the exhaust gas stream and for simultaneously preheating the process air.

16. Process according to claim 1 wherein preheated process air is introduced into the fluidized bed furnace.

17. Process according to claim 1 wherein the fluidized bed furnace is operated at a pressure in the range of -0.2 mbar to -0.3 mbar.

18. The apparatus according to claim 10 having two gas burners.

19. The apparatus according to claim 10 having three gas burners.

20. The apparatus according to claim 10 having a plurality of temperature sensors and at least two of the temperature sensors being vertically spaced from one another.
